(19) United States
(12) Patent Application Publication
(10) Pub. No.: US 2004/0026149 A1
(43) Pub. Date: Feb. 12, 2004

(54) Occupant restraint

(76) Inventor: Donald Raymond Wilkinson, Auckland (NZ)

Correspondence Address: JENSEN + PUNTIGAM, P.S., SUITE 1020, 2033 6TH AVE, SEATTLE, WA, 98121, US

(21) Appl. No.: 10/381,269

(22) PCT Filed: Sep. 19, 2001
(86) PCT No.: PCT/NZ01/00193

(30) Foreign Application Priority Data
Sep. 19, 2000 (NZ) 507028

(51) Int. Cl. B60K 28/04

(52) U.S. Cl. 180/272

(57) ABSTRACT

A restraint (1) for a vehicle which includes an extension (4) adapted in use to be positioned over the body of a vehicle occupant, a connector (5) which when engaged is adapted to secure the extension (4) over the body of a vehicle occupant, and a biasing means associated with the extension (4) adapted to locate at least a portion of the extension (4) in a position where it will at least attract the attention of the vehicle occupant when the connector (5) is not engaged.

### TECHNICAL FIELD

This invention relates to an occupant restraint for a vehicle.

Specifically the present invention may be adapted to provide an improved restraint for operators of construction or roadworking equipment, or any other type of similar mobile plant or machinery. Reference throughout this specification will also be made to the present invention being used in this application, but those skilled in the art should appreciate that other uses are also considered and reference to the above only throughout this specification should in no way be seen as limiting.

### BACKGROUND ART

Seat belt restraints are well known for road vehicles. Road vehicle seat belts are adapted to restrain a vehicle occupant during a high-seed road impact. Seat belts perform effectively to improve the safety of road vehicle users.

Of increasing concern is the safety of operators of mobile plant or machinery used in construction and roadworking applications and on many farms. This type of equipment can include tractors, excavators, bulldozers or any other type of mobile plant. With this type of equipment there is little concern for occupant injury through high-speed impacts. However, because these types of equipment normally lift and lever relatively heavy loads there is increased potential for the equipment to tip or roll if used incorrectly or in an unstable position.

These types of equipment normally include a roll cage surrounding an operator cab. If the operators stays within the roll cage when the equipment tips or rolls they are unlikely to be incurred. To ensure that the operator stays within the roil cage most equipment also includes a basic lap or seat belt that allows the operator to buckle themselves into place on a seat next to the equipment's controls.

However, the applicants have found that operators do not tend to be aware of or use these seat belts. Because of the slow speed of the equipment some operators assume that they are unlikely to be hurt in the event of an accident. Furthermore, operators need to have easy access into and out of their equipment to check on the areas they are working on, and as such engaging and disengaging a seat belt further complicates and slows down their movements.

A common form of seat belt provided with such equipment is a lap belt, which when disengaged will fall away from the operator's seat in the equipment cab and lie on the floor of the cab. In this position the seat belt can easily become wet and dirty, increasing the operator's reluctance to use it. Furthermore, in this position the lap belt will be out of the way of the operator and hence can be easily ignored.

An improved occupant restraint that addressed any or all of the above problems would be of advantage. Specifically an apparatus which encouraged operators to restrain themselves within the cab of a piece of equipment or mobile plant would be of advantage. Furthermore an occupant restraint that also clearly indicated to the employer or supervisor of the operator that the occupant restraint was not engaged would also be of advantage.

It is an object of the present invention to address the foregoing problems or at least to provide the public with a useful choice.

Further aspects and advantages of the present invention will become apparent from the ensuing description that is given by way of example only.

### DISCLOSURE OF INVENTION

According to one aspect of the invention there is provided a restraint for an occupant of a seat, including a restraining member adapted to restrain the occupant when the restraining member is connected to an anchor means, said restraining member being constructed to remain in an elongated extended form when released so that the member is adapted to extend at least partly across the seat in a manner which hinders the operation of the vehicle by the occupant to encourage connection of the restraining member to the anchor means.

The biasing means is preferably adapted to locate the extension in close proximity to the head of the vehicle occupant when the connector is not engaged, and more preferably is adapted to locate the extension in front of the head of the vehicle occupant when the connector is not engaged.

The occupant restraint preferably includes an indication means adapted to indicate to an observer when the connector is not engaged.

The indication means preferably includes a sleeve forming the outer surface of the extension, where this sleeve is brightly coloured.

According to a further preferred embodiment of the present invention, the restraining member includes an expansion means and the expansion means is adapted to increase or decrease the length of the restraining member.

The preferred occupant restraint is suitable for any vehicle. The vehicle in question may be any type of equivalent, machinery or mobile plant which normally operates at relatively low speeds but is used to shift, move or work with heavy loads that could tip or roll the equipment. However, the invention may be used with any other type of vehicle or apparatus in which the occupant may wish to be restrained. The present invention may for example be used in standard road vehicles as an improvement to or a replacement for seat belts normally used to restrain the occupants of such vehicles.

Reference throughout this specification will also be made to the vehicle with which the present invention is used with being an excavator. However, those skilled in the art should be appreciated that any type of vehicle mobile plant, equipment or machinery may also incorporate or use the present invention and reference to excavators only throughout this specification should in no way be seen as limiting. For example, the present invention may be used with cars, trucks, excavators, tractors, dump trucks, graders, or any other similar machinery in which operator restraint could lead to improved safety.

The preferred embodiment of the present invention is adapted to provide a restraint for the occupant of an excavator. The present invention restrains the motion of an excavator's occupant so that preferably the occupant cannot leave a seat provided within the cab of the excavator without deliberately disengaging the apparatus. Furthermore, the occupant to be restrained may normally be the operator of the excavator who is to be restrained in the seat provided adjacent to the excavator's controls.

Reference throughout this specification will also be made to the present invention being used to restrain the operator of an excavator in the seat provided next to the excavator's controls but again those skilled in the art should appreciate that this should in no way be seen as limiting.

Preferably the restraint includes an extension which is adopted in use to be positioned over the body of the excavator operator. Such an extension may be located in such a position as to restrain the operator from moving out of their seat. The extension involved may be shaped or configured in any number of ways to achieve this aim of the present invention. For example, in some embodiments the extension may provide components substantially similar in shape and appearance to a lap belt or alternatively a torso harness that will in use lie over the body of the operator. Alternatively, in some embodiments the extension may be configured as a solid bar or cagelike element that in use is adapted to move to and be located over the body of the operator when in use, and when disengaged makes operation inconvenient.

Reference throughout this specification will however be made to the extension being configure as a lap belt type element that in use is adapted to lie across the waist of the operator. An extension configured as a lap belt need not necessarily be formed from flexible fabric belt but may be constructed from any type of material required to implement the present invention. Reference throughout this specification to the extension being configured as a lap belt should also not be considered limiting. Those skilled in the art should appreciate that an extension may be configured with any shape or appearance that in use will restrain the operator in their seat.

In a preferred embodiment the present invention also includes a connector which can be engaged to secure the extension over the body of the operator. Such a connector may be engaged or disengaged at will by the operator to allow them to restrain themselves within the excavator seat or release themselves from the excavator seat.

Preferably the connector may be a standard seat belt type connector used in normal road vehicles. These types of connectors are well known and can be manufactured at relatively low cost. Preferably the connector used may also be strengthened so as to ensure that it will not release or disengage if the excavator is turned entirely upside down and the entire weight of the operator is acting to pull the connector open.

In a preferred embodiment the present invention includes a biasing means associated with the extension which in use is adapted to locate at least a portion of the extension in a position where it will attract the attention of the vehicle occupant when the connector is not engaged. Alternatively, the biasing means may also be adapted to place portion of the extension in a location where it will hinder the operation of the vehicle by the occupant when the connector is not engaged. This configuration of the invention ensures that if the extension is not used to restrain the operator then the operator cannot easily operate the excavator nor easily ignore the extension. This will promote increased use of the present invention to adequately restrain an operator when they are sitting within the cab of an excavator.

In a further preferred embodiment such a biasing means may locate an end of the extension attached to the connector in close proximity to the head of the vehicle occupant when the connector is not engaged. This configuration of the invention will place one end of the extension right within the line of sight of the operator when the connector is not engaged may also result in the extension swinging around and potentially hitting the operator when the excavator is moved or used. This positioning of the extension will prevent the operator from ignoring the extension and will hopefully promote frequent use of the invention.

However, in an alternative embodiment the biasing means may be adapted to locate an end or portion of the extension in a position where it will interfere with the operation of the excavator. For example in one embodiment when the connector is not engaged the biasing means may place one end of the extension directly over the top of the controls used to operate the excavator. This positioning of the extension will make it impossible for the operator to operate the excavator while ignoring the extension. The applicants envision that the positioning of the extension by the biasing means will create an annoyance for the operator that will promote or encourage them to engage the connector and secure themselves within the excavator.

In a preferred embodiment a biasing means may be formed by a resilient component which preferably runs through the length of the extension. Such a resilient component may be bent, stretched, or deformed when the connector is engaged but may spring back into its original position and shape when the connector is disengaged.

In a further preferred embodiment such a resilient biasing means may be formed from components similar to a leaf spring running through the body of the extension, for example, in one embodiment a biasing means may be formed from a flexible length of plastic running through the length of the extension. However, any type of substantially resilient member that will allow the biasing means to perform effectively may also be used in conjunction with the present invention.

In a further preferred embodiment the biasing means may be in excess of 100 millimetres in width. This allows the present invention to be used in conjunction with existing 50 millimetre seat belts which would not normally be used with such equipment for fear of injuring the equipment operator if the equipment is tipped upside down and the occupant is suspended from their seatbelt. The present invention may be retro fitted to existing 50 to 75 millimetre seat belts to allow them to be used safely in excavators and other similar equipment.

Preferably the present invention may include an indication means which is adapted to indicate to an observer when the connector is not engaged and the extension is not restraining the operator. An observer of such indication means may be an employer or supervisor of the operator who is responsible for the operator's safety on the job site, and who could potentially be held liable or responsible for injuries caused to the operator if an accident occurred. Such an indication means may clearly show anyone in the vicinity of the excavator in question whether or not the operator has engaged the connector and is using the present invention. If the connector is not engaged when it should be, such an observer may see this easily and raise the matter with the operator.

In a further preferred embodiment an indication means may be provided through a sleeve which forms the outer surface of the extension. Such a sleeve may preferably be formed from a brightly coloured material that is wrapped around or forms the entire outer surface of the extension. The use of a brightly coloured material will easily attract the eye of any observers in the vicinity of the excavator when the connector is not engaged and the biasing means is acting to locate the extension in a position where it either hinders the operation of the excavator or attracts the attention of the operator.

In a preferred embodiment the extension may also include an expansion means which is adapted to increase or decrease the length of the extension. Such an expansion means may be used to adjust the length of the extension for the comfort and convenience of the operator. The expansion means may be used to provide a snug fit for the operator between the excavator seat and the extension.

In a further preferred embodiment such an expansion means may be formed from an adjustable loop of fabric or belting which is connected to one end of the apparatus. The overall length of this loop may then be adjusted to modify the length of the extension.

The present invention provides many potential advantages over the prior art.

The present invention may locate the extension in a position where it cannot easily be ignored by an occupant or operator when the connector is not engaged .his positioning of the extension may either directly interfere with the operation of a piece of equipment or alternatively may provide a major distraction or annoyance for an operator or occupant of the vehicle or equipment.

Furthermore, the present invention may be adapted so as to indicate to a nearby observer that the connector is not engaged and that the invention is not in use. This will allow the employers or supervisors of vehicle occupants and operators to easily set if the present invention is engaged. This configuration of the invention will also provide a deterrent to operators or occupants of vehicles or equipment not using or engaging the connector of the present invention.

### BRIEF DESCRIPTION OF THE DRAWINGS

Further aspects of the present invention will become apparent from the following description that is given by way of example only and with reference to the accompanying drawings in which:

FIG. 1 shows a side view of an occupant restraint as configured in accordance with a preferred embodiment of the present invention; and

FIG. 2 shows a front view of the apparatus shown with respect to FIG. 1;

FIG. 3 shows a top view of the apparatus shown with respect to FIGS. 1 and 2 where the apparatus is both engaged and disengaged; and

FIG. 4 shows the restraint partly exposed to show the biasing means.

### BEST MODES FOR CARRYING OUT THE INVENTION

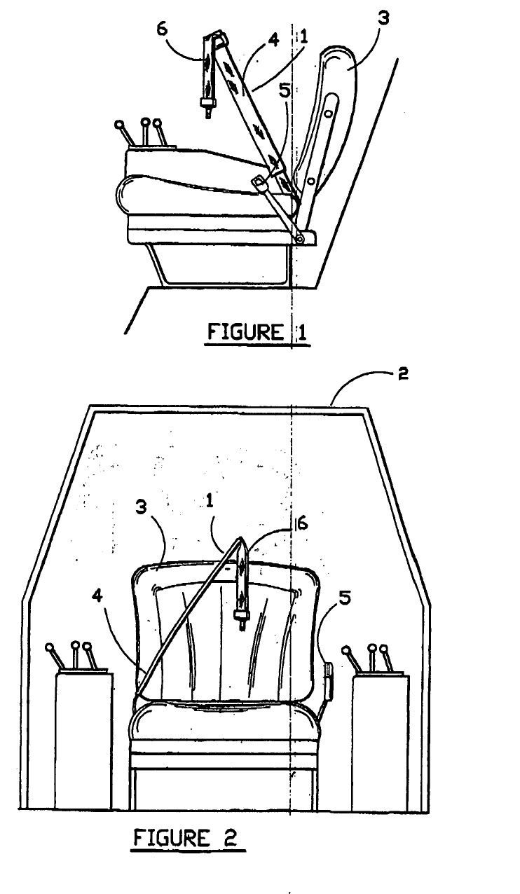

FIGS. 1 and 2 show side and front views of as occupant restraint configured in accordance with a preferred embodiment of the present invention.

In the embodiment shown the restraint 1 is configured to secure the operator of an excavator within the cab 2 of the excavator. The restraint 1 is adapted to secure or restrain an operator with a seat 3 within the cab 2 adjacent to the excavator's controls (not fully shown).

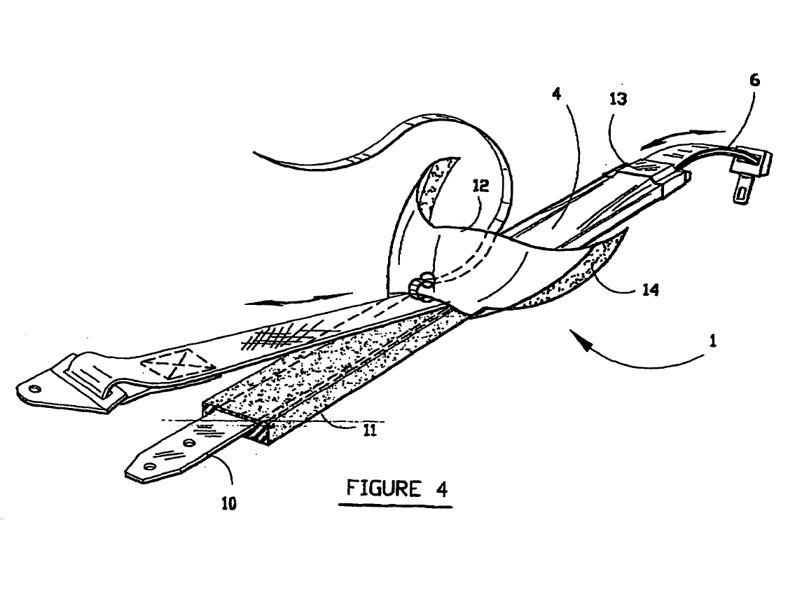

The restraint 1 includes a main extension 4, a connector 5, a biasing means 10 (FIG. 4) running through the length of the extension 4. The biasing means 10 is adapted to place the extension in the position or location shown with respect to FIGS. 1 and 2 when the connector is not engaged to hold the extension over the body of the excavator operator. In this instance the biasing means 10 running along the length of the extension 4 may be constructed from a length of resilient yet flexible plastic or metal which will sit in the position shown when not under the influence of any external forces. The biasing means 10 may be partly or fully enclosed in a foam or rubber sleeve for comfort and protection. The biasing means used is adapted to place the free end 6 of the extension in close proximity to the head of an operator when the operator sits in the seat 3. This positioning of the end of the extension makes it difficult for the operator to ignore the presence of the extension and therefore leave the extension unconnected to the connector 5. For example, in the form shown it will interfere with the ability of the driver to steer, change gears or otherwise operate the device. The operator can simply remove the extension from close proximity to their head and face by engaging the connector with the free end 6 of the extension which will hold the extension onto their lap and away from their face.

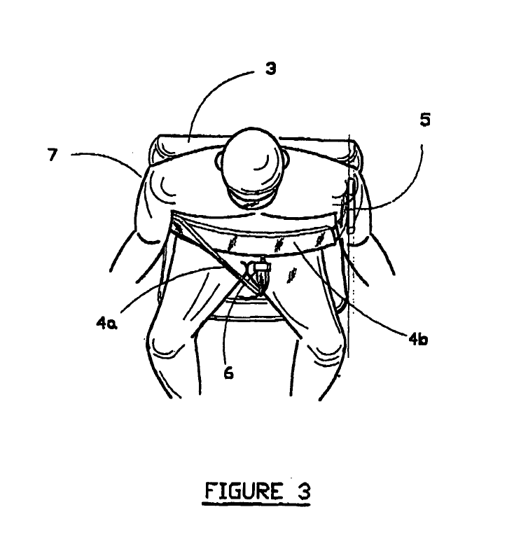

FIG. 3 shows a top view of the apparatus shown with respect to FIG. 1 with the extension shown both with the connector engaged and disengaged and with an operator seated within the seat 3.

As can be seen from FIG. 3 the extension 4 will normally sit in the position 4a when its free end 6 is not engaged to the connector 5. However, the resilient biasing means 10 within the body of the extension will allow it to be bent over into the position shown with respect to reference 4b to place the extension over the lap of an occupant 7 of the vehicle or equipment involved. The extension will also be held in this position when the connector is engaged. In this position the extension will firmly yet comfortably restrain the operator 7 within their seat 3 thereby preventing them from coming to harm if the vehicle or equipment in question rolls or tips over.

As illustrated in FIG. 4, the biasing means 10 is enclosed in a foam rubber or plastics sleeve 11 to protect the occupant and make the device comfortable. The sleeve 11 is enclosed in a fabric casing 12 which is held together around the sleeve by suitable means such as Velcro (Reg'd ™) 14 or some other suitable fastener, and/or a series of press studs (not shown).

An end cap 13 encloses the and of the device as illustrated.

Aspects of the present invention have been described by way of example only and it should be appreciated that modifications and additions may be made thereto without departing from the scope thereof.

1. A restraint for an occupant of a seat, including a restraining member adapted to restrain the occupant when the restraining member is connected to an anchor means, said restraining member being constructed to remain in an elongated extended form when released so that the member is adapted to extend at least partly across the seat in a manner which hinders the operation of the vehicle by the occupant to encourage connection of the restraining member to the anchor means.

2. The restraint as claimed in claim 1 wherein the restraining member includes a biasing means which causes the restraining member to adopt said elongated extended form.

3. The restraint as claimed in claim 1 or claim 2 wherein the restraining member comprises an extension adapted in use to be positioned over the body of the occupant and a connector securable in the anchor means to secure the extension over the body of the occupant.

4. The restraint as claimed in claim 3 wherein, with the connector secured with the anchor, the extension is such as to extend across the lap of the occupant.

5. The restraint of claim 2 or 3 or 4 when dependent on claim 2, wherein the biasing means is adapted to locate the extension in close proximity to the head of the occupant when the connector is not engaged with the anchor means.

6. The restraint of claim 5 wherein the biasing means is adapted to locate the extension in front of the head of the occupant when the connector is not engaged.

7. The restraint of any one of the preceding claims further including an indication means adapted to indicate to an observer when the connector is not engaged.

8. The restraint of claim 7 wherein the indication means includes a sleeve forming an outer surface of the extension, said sleeve being brightly coloured.

9. The restraint of any one of the preceding claims further comprising the extension including an expansion means adapted to increase or decrease the length of the extension.
